(19) United States
(12) Patent Application Publication
(10) Pub. No.: US 2008/0083854 A1
(43) Pub. Date: Apr. 10, 2008

(54) Heated/vibrating keyboard tray and mouse pad

(75) Inventor: James Falk, Carrollton, TX (US)

Correspondence Address: JAMES FALK, 3310 HILLPARK LN, CARROLLTON, TX, 75007, US

(73) Assignee: James Falk, Carrollton, TX (US)

(21) Appl. No.: 11/545,118

(22) Filed: Oct. 10, 2006

(51) Int. Cl. B68G 5/00

(52) U.S. Cl. 248/118

(57) ABSTRACT

A raised heated pad or tray that a computer keyboard and/or mouse sits on which vibrates and provides warmth as it supports the wrist during use.

### REFERENCES CITED

US Patent Documents

| | | |
|---|---|---|
| 6767605 | July 2004 | Raciborski |
| 5197699 | April 1991 | Smith; Mark R |
| 6035789 | March 2000 | Ben-Haim; Niv |
| 3637454 | January 1972 | Pavernick |
| 5228655 | July 1993 | Garcia et al. |
| 5355811 | October 1994 | Brewer |
| 5374018 | December 1994 | Daneshvar |
| 5593128 | January 1997 | Odom |
| 6187398 | February 2001 | Eldridge |

### BACKGROUND OF THE INVENTION

This invention relates to computer keyboards, mousepads and tracking aids, it has a raised/elevated wrist support within which a heating/warming element and a small vibration device are located.

A computer keyboard and computer mouse are input devices used to aid in the placement and processing of information into a computer. Typically these devices are used together, both devices are normally operated on a flat surface. In the case of a computer mouse a special surface is provided—a mousepad. Mousepads may be provided in practically any size or shape, and typically are quite thin, in order to reside on a flat surface near to the computer keyboard.

This invention will support the wrist and provide warmth and vibration which will help to reduce swelling, alleviate pain, and increase blood circulation into and through the wrist. Although there are many mousepads that provide wrist support (examples U.S. Pat. Nos. 6,767,605 & 5,197,699) none provide heating or vibration elements within that reduce the muscle tensions, inflammations and “Cold Hands” associated with the effects of *Carpal Tunnel Syndrome.

*Carpal Tunnel: Many Computer users (as many as 10%) are suffering wrist pains associated with the use of keyboards and a Mouse known as Carpal Tunnel Syndrome—a painful progressive condition caused by compression of a key nerve in the wrist As many as 31,000 cases are reported each year.
http://www.ninds.nih.gov/disorders/carpal tunnel/carpal tunnel.htm
http://pubs.acs.org/subscribe/journals/mdd/v04/i03/html/03health.html

### BRIEF DESCRIPTION OF THE DRAWINGS

Figures: Attached to this claim are drawings labeled FIGS. 1 and 2 showing:

FIG. 1—Mouse: depicts size of Mouse pad with raised pad in which the heating and vibration elements are built into the wrist support element.

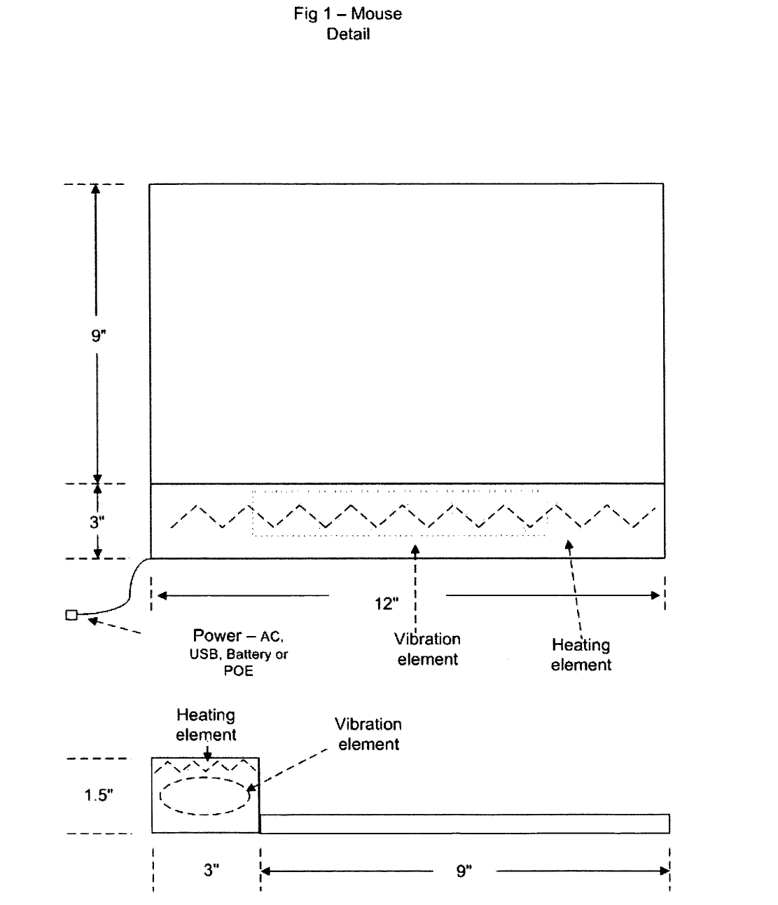

FIG. 2—Keyboard: depicts size of Keyboard pad with raised pad in which heating and vibration elements are built into the wrist support element.

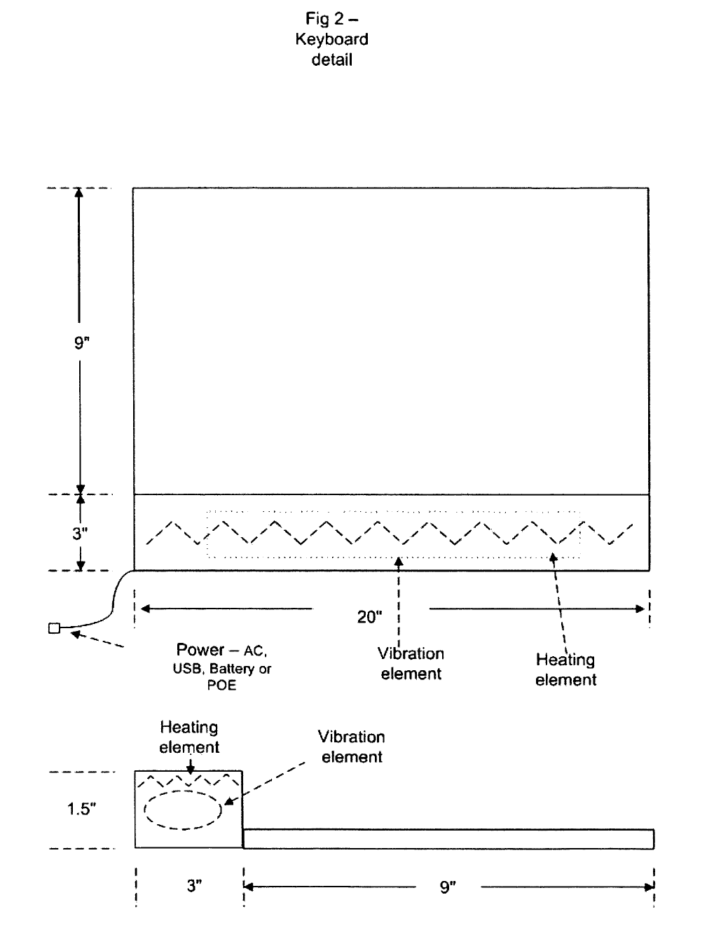

What is claimed

1. A *Raised Heated Keyboard Tray where a small heating and vibration element is placed into a raised platform that provides support for the wrist at approximately the same height as the keyboard and/or mouse itself and provides a soothing heat and vibration to reduce swelling and inflammation of the wrist.

2. A *Raised Heated Mouse Pad where a small heating and vibration element is placed into a raised platform that provides support for the wrist at approximately the same height as the keyboard and/or mouse itself and provides a soothing heat and vibration to reduce swelling and inflammation of the wrist.
